(19) United States
(12) Patent Application Publication
(10) Pub. No.: US 2025/0251337 A1
(43) Pub. Date: Aug. 7, 2025

(54) Wear Degree Measuring Device and Wear Degree Measuring System Including the Same

(71) Applicant: LG Energy Solution, Ltd., Seoul (KR)

(72) Inventor: Chang Il Yoo, Daejeon (KR)

(73) Assignee: LG Energy Solution, Ltd., Seoul (KR)

(21) Appl. No.: 18/696,114

(22) PCT Filed: Jan. 10, 2023
(86) PCT No.: PCT/KR2023/000456

§ 371 Date: Dec. 3, 2024

(30) Foreign Application Priority Data
Jan. 10, 2022 (KR) 10-2022-0003645

(51) Int. Cl. G01N 19/08

(52) U.S. Cl. CPC G01N 19/08

(57) ABSTRACT

A wear degree measuring device measures a wear degree of a pipe, in which a powder is transferrable through a transfer space of the pipe. The pipe is formed by joining an inner pipe and an outer pipe. The wear degree measuring device includes a wear measurement port provided on an outer surface of the outer pipe and a wear measurement unit installed by being inserted into the wear measurement port. The wear measurement unit is formed so that a measurement surface provided at an end thereof penetrates the pipe to face the transfer space, and the wear measurement unit measures a wear degree of the inner pipe by using a wear degree of the measurement surface.

### CROSS-REFERENCE TO RELATED APPLICATIONS

The present application is a national phase entry under 35 U.S.C § 371 PCT/KR2023/000456 filed on Jan. 10, 2023, which claims the benefit of priority based on Korean Patent Application No. 10-2022-0003645, filed on Jan. 10, 2022, all contents of which are incorporated herein by reference.

### TECHNICAL FIELD

The present disclosure relates to a wear degree measuring device and a wear degree measuring system including the same.

### BACKGROUND ART

With environmental pollution and oil depletion, research and development on power generation based on eco-friendly energy sources are being conducted. In particular, research on secondary batteries is being actively conducted, and the research is being conducted on various aspects such as materials, structure, processes, and systems of secondary batteries.

Secondary batteries go through various processes during their production, and in general, secondary batteries are produced through processes such as an electrode process, an assembly process, and a formation process. Regarding the electrode process, powder, which is a raw material of a secondary battery, is pneumatically transferred through a pipe, and the pipe used in the process takes a form in which a plurality of pipes are combined for stability of the transfer. Friction is inevitably generated when powder is transferred, and there is a need to measure the degree of wear caused by friction.

According to the related art, the wear degree of a pipe made of one layer is measured using ultrasonic waves. For the pipe formed by joining a plurality of layers, it is difficult to measure the wear degree using ultrasonic waves, and the wear degree has to be measured through material analysis after disassembly or transfer.

### DISCLOSURE OF THE INVENTION

### Technical Problem

An aspect of the present disclosure provides a wear degree measuring device and a system including the wear degree measuring device, capable of checking wear degree of a pipe by friction in real time or periodically without performing pipe disassembly or material analysis.

### Technical Solution

According to an aspect of the present disclosure, there is provided a wear degree measuring device measuring a wear degree of a pipe in which a transfer space through which powder is transferrable is provided and that is formed by joining an inner pipe and an outer pipe, the wear degree measuring device including a wear measurement port provided on an outer surface of the outer pipe and a wear measurement unit installed by being inserted into the wear measurement port, in which the wear measurement unit is formed so that a measurement surface provided at an end thereof penetrates the pipe to face the transfer space, and measures a wear degree of the inner pipe by using a wear degree of the measurement surface.

The wear degree measuring device may include a sealing member for sealing a space between the wear measurement port and the wear measurement unit.

The measurement surface may be formed to be coplanar with an inner surface of the inner pipe.

The wear measurement unit may be detachably coupled to the wear measurement port.

A material of the measurement surface may be the same as a material of the inner pipe.

The materials of the measurement surface and the inner pipe may be a ceramic material.

The wear measurement unit may be coupled to the wear measurement port through bolt coupling or pin coupling.

The wear measurement port may be provided in plural.

The wear measurement ports may be installed symmetrically with respect to a transfer direction in which the powder is transferred in the transfer space.

The pipe may include a curved portion in which a transfer direction of the powder is changed, and the wear measurement port may be installed on the curved portion.

According to another aspect of the present disclosure, there is provided a wear degree measuring device measuring a wear degree of a pipe in which a transfer space through which powder is transferrable is provided and that is formed by joining an inner pipe and an outer pipe, the wear degree measuring device including a wear measurement port installed on an outer surface of the outer pipe, a frame unit installed by being inserted into the wear measurement port, and a wear measuring sensor installed by being inserted into a through- hole formed in the frame unit, and the wear measuring sensor is installed to penetrate the outer pipe and face the outer surface of the inner pipe to measure a wear degree of the inner pipe.

The wear measuring sensor may be at least one of a contact sensor, a non-contact sensor, and a pressure sensor.

The wear degree measuring device may include a sealing member for sealing a space between the wear measurement port and the frame unit.

The wear measuring sensor may measure the wear degree of the inner pipe by measuring powder flowing out due to wear of the inner pipe.

The wear measurement port may be provided in plural.

The wear measurement ports may be installed symmetrically with respect to a transfer direction in which the powder is transferred in the transfer space.

The pipe may include a curved portion in which a transfer direction of the powder is changed.

The wear measurement port may be installed in the curved portion.

According to yet another aspect of the present disclosure, there is provided a wear degree measuring system measuring a wear degree of a pipe in which a transfer space through which powder is transferrable is provided and that is formed by joining an inner pipe and an outer pipe, the wear degree measuring system including a wear degree measuring device installed to penetrate the outer pipe on an outer surface of the outer pipe to measure a wear degree of the inner pipe, a user interface formed to check the wear degree of the inner pipe from the outside, and a processor electrically connected to the wear degree measuring device and the user interface, and the processor controls the wear degree measuring device to measure the wear degree of the inner pipe and control the user interface to provide the wear degree to the outside.

The processor may control the user interface to provide a notification to the outside, when the wear degree exceeds a threshold value.

The processor may control the wear degree measuring device to further measure the wear position of the inner pipe.

### Advantageous Effects

According to the aspects of the present disclosure, even in a pipe formed of a plurality of layers, it is possible to measure the wear degree of the inner pipe in real time or periodically.

According to the aspects of the present disclosure, by detecting the position where wear occurs along with the wear degree in a pipe formed of a plurality of layers, it is possible to effectively manage the pipe.

According to the aspects of the present disclosure, it is possible to efficiently replace pipes by automatically checking the wear degree by the generation of wear.

### BRIEF DESCRIPTION OF THE DRAWINGS

FIG. 1 is a view illustrating an arrangement of wear degree measuring devices according to an embodiment of the present disclosure;

FIG. 2 is a view illustrating an arrangement of wear degree measuring devices according to another embodiment of the present disclosure;

FIG. 3 is a view illustrating a wear degree measuring device according to an embodiment of the present disclosure;

FIG. 4 is a view illustrating a wear degree measuring device according to another embodiment of the present disclosure; and

FIG. 5 is a view illustrating a wear degree measuring system according to yet another embodiment of the present disclosure.

### DETAILED DESCRIPTION

Hereinafter, preferred embodiments of the present invention will be described in detail with reference to the accompanying drawings so that those skilled in the art may easily carry out the present disclosure. However, the present disclosure may be implemented in various different forms and is neither limited nor restricted by the following embodiments.

In order to clearly illustrate the present disclosure, detailed descriptions of parts not related to the description or techniques known in the art that may unnecessarily obscure the subject matter of the present disclosure are omitted, and in the specification, when reference numerals are given to components in each of the drawings, the same or similar components will be designated by the same or similar reference numerals through the specification.

Also, terms or words used in this specification and claims should not be restrictively interpreted as ordinary meanings or dictionary-based meanings, but should be interpreted as meanings and concepts conforming to the scope of the present disclosure on the basis of the principle that an inventor can properly define the concept of a term to describe and explain his or her invention in the best ways.

FIG. 1 illustrates an arrangement of wear degree measuring devices according to an embodiment of the present disclosure.

Powder, which is a raw material of a secondary battery, may be pneumatically transferred through a pipe 10, and the pipe used may take a form in which a plurality of pipes are combined for stability of the transfer. The transfer method may not be limited to the above. The powder may be transferred while oscillating up and down with respect to a transfer direction in a transfer space 50.

The pipe 10 may include an outer pipe 20. For example, the pipe 10 may include the outer pipe 20 forming an exterior of the pipe 10. The outer pipe 20 may be formed of a steel-based material such as stainless steel. However, the outer pipe 20 may not be limited thereto.

The pipe 10 may include an inner pipe 40. For example, the pipe 10 may include the inner pipe 40 joined to the outer pipe 20 and forming the transfer space 50. The inner pipe 40 may be formed of a ceramic material. However, the inner pipe 40 may not be limited thereto.

The pipe 10 may include the transfer space 50 therein. For example, the pipe 10 may include the transfer space 50 in which powder is transferrable, and air and powder may be transferred in the transfer space 50 along the transfer direction. The powder may be transferred while oscillating up and down with respect to a transfer direction in a transfer space 50. In the transfer space 50, air and powder of raw materials of the secondary battery may collide with the inner pipe 40 while being transferred, and wear of the inner pipe 40 may occur by the collision.

The outer pipe 20 and the inner pipe 40 may be joined through an intermediate member 30. For example, the intermediate member 30 may be an adhesive member that allows the outer pipe 20 and the inner pipe 40 to be joined to each other.

The pipe 10 may include wear degree measuring devices 100 and 200. For example, the wear degree measuring devices 100 and 200 may be installed on the outer pipe 20 of the pipe 10. The wear degree measuring devices 100 and 200 may be provided in plural. The wear degree measuring devices 100 and 200 may be installed symmetrically with respect to the transfer direction in which the powder is transferred in the transfer space 50.

The wear degree measuring devices 100 and 200 may be installed on the outer pipe 20 of the pipe 10 to measure the wear degree of the inner pipe 40 of the pipe 10. For example, the wear degree measuring devices 100 and 200 may be installed on the outer pipe 20 to penetrate at least the outer pipe 20 to measure the wear degree of the inner pipe 40.

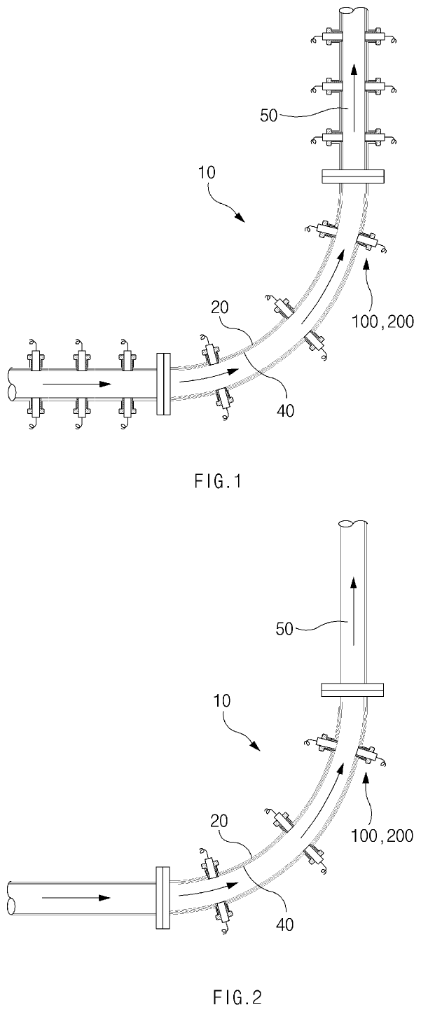

FIG. 2 illustrates an arrangement of wear degree measuring devices according to another embodiment of the present disclosure.

The pipe 10 may include the transfer space 50 in which powder is transferrable, and air and powder may be transferred in the transfer space 50 along the transfer direction. In the transfer space 50, air and powder of raw materials of the secondary battery may collide with the inner pipe 40 while being transferred, and wear of the inner pipe 40 may occur by the collision.

When the pipe 10 includes a curved portion, the wear degree of the curved portion may be greater than that of other portions. For example, the transfer direction in which air and powder are transferred may be changed in the curved portion of the pipe 10, and as the transfer direction of the powder is changed, the powder may collide with the inner pipe 40 of the curved portion. The frequency of the powder colliding with the inner pipe 40 may be higher in the curved portion than in other portions.

The wear degree measuring devices 100 and 200 may be installed on the curved portion of the pipe 10. For example, the wear degree measuring devices 100 and 200 may be installed in the curved portion where the transfer direction of powder is changed in the transfer space 50.

The wear degree measuring devices 100 and 200 may be provided in plural in the curved portion, and may be installed symmetrically with respect to the transfer direction. For example, the wear degree measuring devices 100 and 200 may be installed on the outer pipe 20 to be located on the upper and lower sides based on the transfer direction of powder.

Since the wear degree measuring devices 100 and 200 are installed in the curved portion where the frequency of powder colliding with the inner pipe 40 is high, it is possible to effectively measure the wear degree of the curved portion of the inner pipe 40, which requires periodic replacement of the inner pipe due to wear.

FIG. 3 illustrates the wear degree measuring device 100 according to an embodiment of the present disclosure.

The wear degree measuring device 100 may include a wear measurement port 110. The wear measurement port 110 may be installed on the outer surface of the outer pipe 20. For example, the wear measurement port 110 may be installed on the outer surface of the outer pipe 20 so that a hole in which the wear measurement unit 120 may be accommodated is provided. The wear measurement port 110 may be provided in plural. The wear measurement ports 110 may be installed symmetrically with respect to the transfer direction in which the powder is transferred in the transfer space 50. For example, the wear measurement ports 110 may be installed on the outer pipe 20 to be located on the upper and lower sides based on the transfer direction of powder. Since the wear measurement port 110 is formed at least in the curved portion where the frequency of powder colliding with the inner pipe 40 is high, it is possible for the wear degree measuring device 100 to effectively measure the wear degree of the curved portion of the inner pipe 40, which requires periodic replacement of the inner pipe due to wear.

The wear degree measuring device 100 may include the wear measurement unit 120. The wear measurement unit 120 may be coupled to the wear measurement port 110 to be separable from the wear measurement port 110. For example, the wear measurement unit 120 may be installed by being inserted into a hole capable of accommodating the wear measurement unit 120, which is formed in the wear measurement port 110. In addition, the wear measurement unit 120 may be separated from the wear measurement port 110 by releasing the inserted wear measurement unit 120 from the hole capable of accommodating the wear measurement unit 120. For another example, the wear measurement unit 120 may be coupled to the wear measurement port 110 with bolts or pins. When it is possible to couple or separate the wear measurement unit 120 to or from the wear measurement port 110, there may be no particular limitation on the coupling or installation method.

The wear measurement unit 120 may be formed to penetrate the pipe 10. For example, the wear measurement unit 120 may be formed to penetrate the outer pipe 20 and the inner pipe 40. The wear measurement unit 120 may be installed so that a measurement surface 121 provided at the end thereof penetrates the outer pipe 20 and the inner pipe 40 to face the transfer space 50 of the pipe 10. The measurement surface 121 of the wear measurement unit 120 may be disposed to be coplanar with the inner surface of the inner pipe 40.

At least a part of the wear measurement unit 120 may be made of the same material as that of the inner pipe 40. For example, measurement surface 121 of the wear measurement unit 120 may be made of at least the same material as that of the inner pipe 40. For another example, other parts including the measurement surface 121 of the wear measurement unit 120 may also be made of the same material as the inner pipe 40. The material of the aforementioned inner pipe 40 may be a ceramic material.

The wear degree measuring device 100 may include a sealing material 130. When the wear measurement unit 120 is installed in the wear measurement port 110, a gap may be formed between the wear measurement port 110 and the wear measurement unit 120. The sealing material 130 may be a member for sealing a space (e.g., a gap space) between the wear measurement port 110 and the wear measurement unit 120.

The wear degree of the measurement surface 121 of the wear measurement unit 120 may correspond to the wear degree of the inner surface of the inner pipe 40. For example, the measurement surface 121 formed at the end of the wear measurement unit 120 may be located to be coplanar with and made of the same material as the inner pipe 40, and thus, the wear degree indicating the degree of wear of the measurement surface 121 may be the same as or similar to the wear degree of the inner surface of the inner pipe 40.

The wear degree measuring device 100 may measure the wear degree of the inner pipe 40 by using the wear degree of the measurement surface 121 of the wear measurement unit 120. The wear degree measuring device 100 may measure the wear degree of the measurement surface 121 and measure the wear degree of the inner surface of the inner pipe 40 by inference. For example, the wear degree measuring device 100 may measure the wear degree of the measurement surface 121 by using the height at which the measurement surface 121 of the wear measurement unit 120 is worn down. For specific example, when wearing on the measurement surface 121 is in progress, the lowering of height of the measurement surface 121 may be measured through the wear degree measuring device 100, and the thickness of the inner pipe 40 may be reduced corresponding to the wear of the measurement surface 121. The wear degree measuring device 100 may measure the wear degree of the inner pipe 40 by inference through the height of the lowered measurement surface 121. For another example, the wear degree measuring device 100 may measure the wear degree of the measurement surface 121 by using the reduced weight of the wear measurement unit 120 due to wear. For specific example, when wearing on the measurement surface 121 is in progress, the reduction in weight of the wear measurement unit 120 may be measured through the wear degree measuring device 100, and the weight of the inner pipe 40 may be reduced corresponding to the wear of the wear measurement unit 120. The wear degree measuring device 100 may measure the wear degree of the inner pipe 40 by inference through the reduced weight of the wear measurement unit 120.

The wear degree measuring device 100 may measure the wear degree of the inner pipe 40 by inference by measuring the wear degree of the measurement surface 121, as described above.

When a plurality of wear degree measuring devices 100 are installed in the pipe 10, a plurality of wear measurement units 120 may be installed by being inserted in a plurality of respective wear measurement ports 110, and the wear degrees of the inner pipe 40 corresponding to a plurality of positions may be measured. In addition, by using the wear measuring devices 100, positions where wear occurs frequently or severely in the pipe 10 may be checked.

In measuring the wear degree by using the wear degree measuring device 100, the wear degree may be checked by releasing the inserted wear measurement unit 120 periodically or in real time, and thus the position where wear occurs and the wear degree of the position may be checked periodically or in real time, whereby pipe management and replacement may be effectively performed.

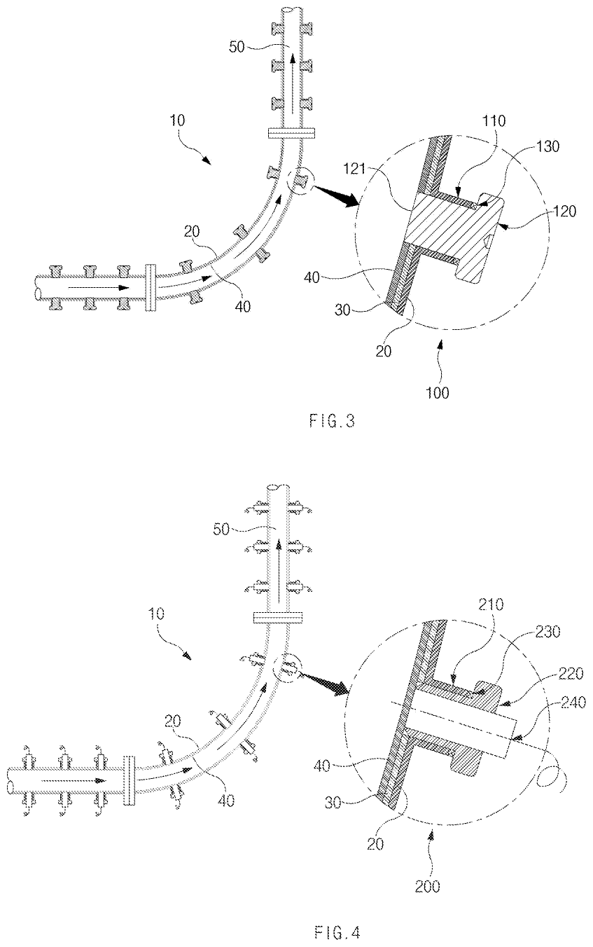

FIG. 4 illustrates a wear degree measuring device 200 according to another embodiment of the present disclosure.

The wear degree measuring device 200 may include a wear measurement port 210. The wear measurement port 210 may be installed on the outer surface of the outer pipe 20. For example, the wear measurement port 210 may be installed on the outer surface of the outer pipe 20 so that a hole in which a frame unit 220 may be accommodated is provided. The wear measurement port 210 may be provided in plural. The wear measurement ports 210 may be installed symmetrically with respect to the transfer direction in which the powder is transferred in the transfer space 50. For example, the wear measurement ports 210 may be installed on the outer pipe 20 to be located on the upper and lower sides based on the transfer direction of powder. Since the wear measurement port 210 is formed at least in the curved portion where the frequency of powder colliding with the inner pipe 40 is high, it is possible for the wear degree measuring device 200 to effectively measure the wear degree of the curved portion of the inner pipe 40, which requires periodic replacement of the inner pipe due to wear.

The wear degree measuring device 200 may include the frame unit 220. The frame unit 220 may be coupled to the wear measurement port 210 to be separable from the wear measurement port 210. For example, the frame unit 220 may be installed by being inserted into a hole capable of accommodating the frame unit 220, which is formed in the wear measurement port 210. In addition, the frame unit 220 may be separated from the wear measurement port 210 by releasing the inserted frame unit 220 from the hole capable of accommodating the frame unit 220. For another example, the frame unit 220 may be coupled to the wear measurement port 210 with bolts or pins. When it is possible to couple or separate the frame unit 220 to or from the wear measurement port 210, there may be no particular limitation on the coupling or installation method. The frame unit 220 may be formed to penetrate the pipe 10. For example, the frame unit 220 may be disposed to penetrate the outer pipe 20. In addition, the frame unit 220 may include a through-hole for accommodating a wear measuring sensor 240.

The wear degree measuring device 200 may include a sealing material 230. The sealing material 230 may be a member for sealing a space (e.g., a gap space) between the wear measurement port 210 and the frame unit 220.

The wear degree measuring device 200 may include the wear measuring sensor 240. The wear measuring sensor 240 may be at least one of a contact sensor, a non-contact sensor, and a pressure sensor. The wear measuring sensor 240 may be installed by being inserted into a through-hole formed in the frame unit 220. The wear measuring sensor 240 may be disposed to penetrate the outer pipe 20 to face the outer surface of the inner pipe 40. The wear measuring sensor 240 may be disposed to be in contact with or not to be in contact with the outer surface of the inner pipe 40, while facing the outer surface of the inner pipe 40.

The wear measuring sensor 240 may measure the wear degree of the inner pipe 40 by measuring powder flowing out due to wear of the inner pipe 40. For example, the wear of the inner pipe 40 may progress due to the transfer of powder, and when the wear of the inner pipe 40 continues, a part of the inner pipe 40 may be damaged (e.g., a hole is formed through a part thereof). The powder may flow out of the transfer space 50 through a hole formed in the inner pipe 40. The wear measuring sensor 240 may measure the powder flowing out through a damaged area due to the wear of the inner pipe 40. For example, the wear measuring sensor 240 may be disposed to face the inner pipe 40 in contact or in non-contact with the inner pipe 40, and may measure the outflow amount, the outflow speed, and the outflow position of the powder flowing out. For another example, the wear measuring sensor 240 may measure the outflow pressure of the powder flowing out of the inner pipe 40.

The wear degree measuring device 200 may measure the wear degree of the inner pipe 40 by using at least one of the outflow amount, the outflow speed, the outflow position, and the outflow pressure of the powder measured by the wear measuring sensor 240.

As described above, the wear degree measuring device 100 may measure the wear degree of the inner pipe 40 by inference by measuring parameters for the powder flowing out using the wear measuring sensor 240.

When a plurality of wear degree measuring devices 200 are installed in the pipe 10, a plurality of frame units 220 may be installed by being inserted in a plurality of respective wear measurement ports 210, and the wear degrees of the inner pipe 40 corresponding to a plurality of positions may be measured. In addition, by using the wear measuring sensors 240, the wear measuring device 200 may check positions where wear occurs frequently or severely in the pipe 10.

In measuring the wear degree by using the wear degree measuring device 200, the wear degree of the inner pipe 40 may be checked periodically or in real time by using the wear measuring sensor 240, and thus the position where wear occurs and the wear degree of the position may be checked periodically or in real time, whereby pipe management and replacement may be effectively performed.

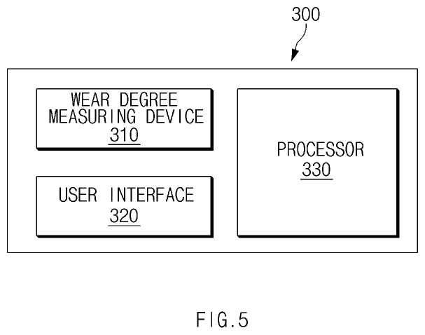

FIG. 5 illustrates a wear degree measuring system 300 according to yet another embodiment of the present disclosure.

The wear degree measuring system 300 may include a wear degree measuring device 310. The wear degree measuring device 310 may be a device corresponding to the wear degree measuring device 100 or 200 described in FIGS. 1 to 4. The wear degree measuring device 310 may correspond to the wear degree measuring device 100 or the wear degree measuring device 200, and thus the description of the wear degree measuring device 100 or the wear degree measuring device 200 described in FIGS. 1 to 4 may also be applied to the wear degree measuring device 310.

The wear degree measuring system 300 may include a user interface 320. The user interface 320 may be formed so that the wear degree of the inner pipe 40 measured by the wear degree measuring device 310 is checked from the outside.

The wear degree measuring system 300 may include a processor 330. The processor 330 may be electrically or operatively connected to the wear degree measuring device 310 and the user interface 320. The processor 330 may control operations of the wear degree measuring device 310 and the user interface 320.

The wear degree measuring system 300 may control the wear degree measuring device 310 using the processor 330 to measure the wear degree of the inner pipe 40. Furthermore, the wear degree measuring system 300 may control the wear degree measuring device 310 using the processor 330 to measure the wear position of the inner pipe 40.

The wear degree measuring system 300 may control the user interface 320 using the processor 330 to provide at least one of the measured wear degree and wear position of the inner pipe 40 to the outside. For example, the wear degree measuring system 300 may control the wear degree measuring device 310 to visually provide at least one of the measured wear degree and wear position of the inner pipe 40 through the user interface 320 so that an external user may check it periodically or in real time. For another example, the wear degree measuring system 300 may control the user interface 320 to provide a notification of the wear degree and the wear position to the outside, when the wear degree of the inner pipe 40 measured by controlling the wear degree measuring device 310 exceeds a threshold value.

As described above, the wear degree and wear position corresponding to the wear occurring in the inner pipe 40 may be checked using the wear degree measuring device 100 or the wear degree measuring device 200, and the checked wear degree and wear position may be provided to the user through the user interface 320.

The user may check the wear degree caused by the friction between the powder and the inner pipe 40 in real time or periodically using the wear degree measuring device 100 or the wear degree measuring device 200, without performing pipe disassembly or material analysis. Therefore, management and replacement of the pipe 10 may be effectively performed by detecting the wear degree of the inner pipe 40 and the position where wear occurs in the pipe 10 formed by joining a plurality of pipes.

While the present disclosure has been hereinabove described with regard to a limited number of embodiments and drawings, the present disclosure is not limited thereto and it is obvious to those skilled in the art that various modifications and changes may be made thereto within the technical aspects of the present disclosure and the equivalent scope of the appended claims.

### DESCRIPTION OF THE SYMBOLS

10: pipe
20: outer pipe
30: intermediate member
40: inner pipe
50: transfer space
100: wear degree measuring device
110: wear measurement port
120: wear measurement unit
121: measurement surface
130: sealing material
200: wear degree measuring device
210: wear measurement port
220: frame unit
230: sealing material
240: wear measuring sensor
300: wear degree measuring system
310: wear degree measuring device
320: user interface
330: processor

1. A wear degree measuring device measuring a wear degree of a pipe in which a transfer space through which powder is transferrable is provided and that is formed by joining an inner pipe and an outer pipe, the wear degree measuring device comprising:
a wear measurement port provided on an outer surface of the outer pipe; and
a wear measurement unit installed by being inserted into the wear measurement port,
wherein the wear measurement unit:
is formed so that a measurement surface provided at an end thereof penetrates the pipe to face the transfer space; and
measures a wear degree of the inner pipe by using a wear degree of the measurement surface.

2. The wear degree measuring device of claim 1, further comprising a sealing member for sealing a space between the wear measurement port and the wear measurement unit.

3. The wear degree measuring device of claim 1, wherein the measurement surface is formed to be coplanar with an inner surface of the inner pipe.

4. The wear degree measuring device of claim 1, wherein the wear measurement unit is detachably coupled to the wear measurement port.

5. The wear degree measuring device of claim 1, wherein a material of the measurement surface is the same as a material of the inner pipe.

6. The wear degree measuring device of claim 5, wherein the materials of the measurement surface and the inner pipe are a ceramic material.

7. The wear degree measuring device of claim 1, wherein the wear measurement unit is coupled to the wear measurement port through bolt coupling or pin coupling.

8. The wear degree measuring device of claim 1, wherein the wear measurement port is provided in plural.

9. The wear degree measuring device of claim 8, wherein the wear measurement ports are installed symmetrically with respect to a transfer direction in which the powder is transferred in the transfer space.

10. The wear degree measuring device of claim 9, wherein the wear measurement ports are installed symmetrically on upper and lower sides with respect to the transfer direction.

11. The wear degree measuring device of claim 1, wherein the pipe includes a curved portion in which a transfer direction of the powder is changed, and
the wear measurement port is installed on the curved portion.
